(19) United States
(12) Patent Application Publication
(10) Pub. No.: US 2015/0269534 A1
(43) Pub. Date: Sep. 24, 2015

(54) INFORMATION PROVISION APPARATUS, SERVER APPARATUS, INFORMATION PROVISION METHOD, AND INFORMATION PROVISION PROGRAM

(71) Applicant: PANASONIC INTELLECTUAL PROPERTY CORPORATION OF AMERICA, Torrance, CA (US)

(72) Inventor: Kotaro Sakata, Tokyo (JP)

(21) Appl. No.: 14/436,114

(22) PCT Filed: Jul. 1, 2014
(86) PCT No.: PCT/JP2014/003505

§ 371 Date: Apr. 16, 2015

(30) Foreign Application Priority Data
Aug. 29, 2013 (JP) 2013-177690

(51) Int. Cl. G06Q 10/00

(52) U.S. Cl. CPC G06Q 10/20

(57) ABSTRACT

An information provision apparatus (20) has the following: a presentation-information reception unit (21) that receives presentation information generated by a server (10) and stores said presentation information in a prescribed storage unit; and a presentation unit (22) that presents the presentation information to the user of the device (20), said presentation information having been read out from the aforementioned storage unit. The presentation information indicates, at least and on a per-action basis, what actions were taken by users of the same model as or similar models to the abovementioned device (20) upon malfunctions in the devices used by said users. For cases in which the malfunctioning device was replaced, the presentation information includes information that indicates the newly purchased model, and for cases in which the malfunctioning device was repaired, the presentation information includes information that indicates where the user had the device repaired.

### TECHNICAL FIELD

The present invention relates to an information providing apparatus, a server apparatus, an information providing method and an information providing program that provide information relating to consumer home electronics to users.

### BACKGROUND ART

Conventionally, there are proposals for systems that guide users using consumer home electronics (hereinafter referred to as “home appliances”) in easily making a request, in the event of malfunction (including defects), for repair using a display screen.

As such an example, there is a system that notifies, when a defect occurs in a device, the user of a defect on a display screen, receives a decision as to whether or not to make a request for repair to a support center and notifies, upon receiving the request for repair, the support center of the request (e.g., see Patent Literature (hereinafter, referred to as “PTL”) 1).

As another example, there is a system that notifies, when a malfunction occurs in gas appliances, a repair service center of information on the malfunction, receives a selection of a date/time presented from the repair service center in reply on a display screen and notifies, upon receiving the selection of a date/time, the repair service center of the selection (e.g., see PTL 2).

### CITATION LIST

### Patent Literature

### PTL 1

### Japanese Patent Application Laid-Open No. 2005-250718

### PTL 2

### Japanese Patent Application Laid-Open No. 2003-303244

### SUMMARY OF INVENTION

### Technical Problem

When a malfunction occurs in a device, the systems in PTLs 1 and 2 propose only repair to the user. However, there are currently a growing number of users who use information on web sites or the like without swallowing an estimate or proposal whole of one company and desire to thereby achieve smarter consumption activity. That is, the users' sense of value is becoming more and more diversified and there is a difference in opinions on the intention as to whether to select replacement by purchase or repair. Therefore, the systems in PTLs 1 and 2 proposing only repair to users cannot sufficiently support the users' consumption activity.

An object of the present invention is to provide an information providing apparatus, a server apparatus, an information providing method and an information providing program capable of providing the user with information as to whether replacement by purchase or repair should be selected as a reference.

### Solution to Problem

An information providing apparatus according to an aspect of the present invention includes: a presentation information receiving section that receives presentation information generated in a server apparatus and that stores the presentation information in a predetermined storage section; and a presentation section that presents the presentation information read from the storage section to a user of a predetermined device, in which the presentation information is information that indicates, by behavior type, what behavior is shown by at least one of a user of a model identical to that of the device and a user of a model similar to that of the device when the device used by the user malfunctions.

A server apparatus according to an aspect of the present invention includes: a behavior information collecting section that collects behavior information relating to behavior shown by a user when a device used by the user malfunctions and that stores the behavior information in a predetermined storage section; a behavior analyzing section that analyzes, for each user, what behavior is shown by the user when the device malfunctions, based on the behavior information read from the storage section; a presentation information generating section that generates presentation information indicating, by behavior type, what behavior is shown by at least one of a user of a device of a model identical to that of the device and a user of a model similar to that of the device when the device malfunctions, based on the analysis result; and a presentation information transmitting section that transmits the presentation information to an apparatus used by the user.

An information providing method according to an aspect of the present invention is a method performed by a server apparatus disposed on a network, the method including: collecting behavior information relating to behavior shown by a user when a device used by the user malfunctions, and storing the behavior information in a predetermined storage section; analyzing, for each user, what behavior is shown by the user, based on the behavior information read from the storage section when the device malfunctions; generating presentation information indicating, by behavior type, what behavior is shown by at least one of a user of a device of a same model as that of the device and a user of a model similar to that of the device when the device malfunctions, based on the analysis result; and transmitting the presentation information to an apparatus used by the user.

An information providing program according to an aspect of the present invention is a program that causes a computer disposed on a network to execute processing, the program including the processing of: collecting behavior information relating to behavior shown by a user when a device used by the user malfunctions, and storing the behavior information in a predetermined storage section; analyzing, for each user, what behavior is shown by the user when the device malfunctions, based on the behavior information read from the storage section; generating presentation information indicating, by behavior type, what behavior is shown by at least one of a user of a same model as that of the device and a user of a model similar to that of the device when the device malfunctions, based on the analysis result; and transmitting the presentation information to an apparatus used by the user.

### Advantageous Effects of Invention

According to the present invention, it is possible to provide to users information as to which of replacement by purchase or repair should be selected as a reference.

### BRIEF DESCRIPTION OF DRAWINGS

FIGS. 1A to 1C illustrate an example of an overall image of an information providing system according to Embodiments 1 and 2 of the present invention;

FIG. 2 is a block diagram illustrating a configuration example of the information providing system according to Embodiment 1 of the present invention;

FIG. 3 is a sequence diagram illustrating an operation example of the information providing system according to Embodiment 1 of the present invention;

FIG. 4 illustrates an example of collection of behavior information according to Embodiment 1 of the present invention;

FIGS. 5A to 5C illustrate an example of presentation of presentation information according to Embodiment 1 of the present invention;

FIG. 6 is a block diagram illustrating a configuration example of an information providing system according to Embodiment 2 of the present invention;

FIG. 7 is a sequence diagram illustrating an operation example of the information providing system according to Embodiment 2 of the present invention;

FIGS. 8A and 8B illustrate an example of collection of history information according to Embodiment 1 of the present invention; FIGS. 9A and 9B illustrate an example of presentation of information provided by the information providing system according to Embodiment 2 of the present invention;

FIG. 10 illustrates a hardware configuration example of a server and a device according to Embodiments 1 and 2 of the present invention;

FIG. 11 illustrates service genre 1 (own data center type) according to Embodiments 1 and 2 of the present invention;

FIG. 12 illustrates service genre 2 (type using IaaS) according to Embodiments 1 and 2 of the present invention;

FIG. 13 illustrates service genre 3 (type using PaaS) according to Embodiments 1 and 2 of the present invention; and

FIG. 14 illustrates service genre 4 (type using SaaS) according to Embodiments 1 and 2 of the present invention.

### DESCRIPTION OF EMBODIMENTS

Hereinafter, embodiments of the present invention will be described in detail with reference to the accompanying drawings.

(Overall Image of Service Provided)

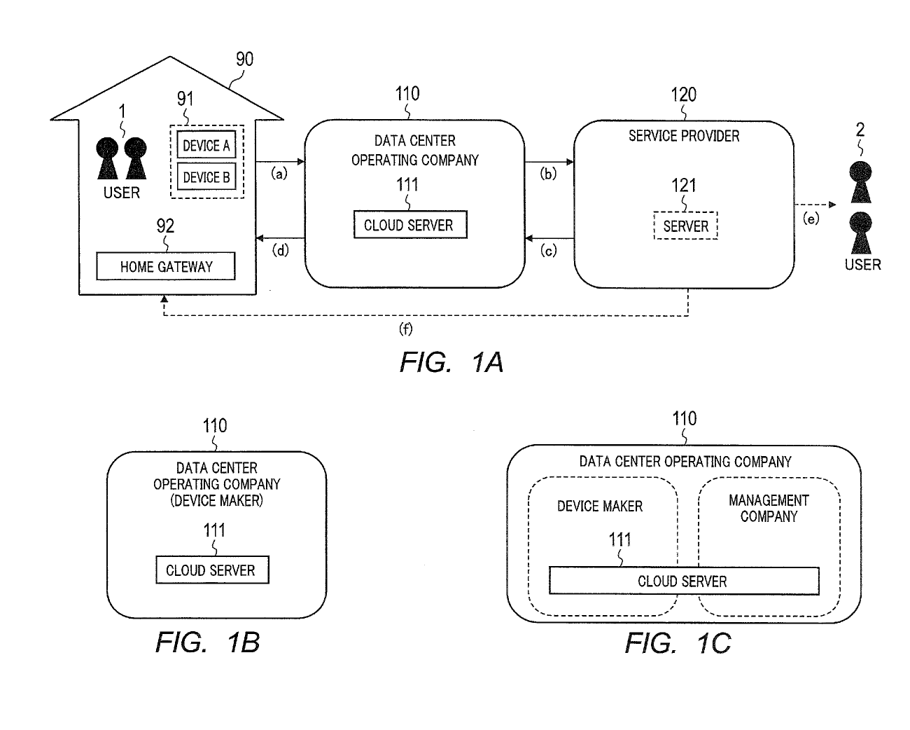

FIG. 1A illustrates an overall image of an information providing system according to the present embodiment.

Examples of group 90 include an enterprise, organization and household, whatever the scale is. Group 90 includes a plurality of devices 91, that is, device A and device B, and home gateway 92. The plurality of devices 91 include devices accessible to the Internet (e.g., smartphone, PC, TV) and devices not accessible to the Internet on their own (e.g., illumination, washing machine, or refrigerator). There may also be devices not accessible to the Internet on their own but connectable to the Internet via home gateway 92. Group 90 also includes user 1 who uses the plurality of devices 91.

Data center operating company 110 includes cloud server 111. Cloud server 111 is a virtualization server that operates in concert with various devices via the Internet. Cloud server 111 mainly manages massive data (big data) or the like which is hard to handle using a normal database management tool. Data center operating company 110 manages data, manages cloud server 111 and operates the data center that performs such management. Details of services provided by data center operating company 110 will be described later. Here, data center operating company 110 is not limited to companies carrying out data management and operation of cloud server 111 or the like. For example, when a device maker which develops and manufactures one of the plurality of devices 91 also manages data and manages cloud server 111, the device maker corresponds to data center operating company 110 (FIG. 1B). The number of data center operating companies 110 is not limited to one. For example, when a device maker and another management company jointly perform or share data management and operation of cloud server 111, one or both of them correspond(s) to data center operating company 110 (FIG. 1C).

Service provider 120 owns server 121. Server 121 referred to here includes, for example, a memory in a personal PC, whatever the scale is. There may be a case where the service provider does not possess any server 121.

In the above-described services, home gateway 92 is not indispensable. For example, when cloud server 111 manages all data or the like, home gateway 92 is unnecessary. When all devices in a household are connected to the Internet, there may be a case where there is no device which is not accessible to the Internet on its own.

Next, an information flow in the above-described service will be described.

First, device A or device B of group 90 transmits each piece of log information to cloud server 111 of data center operating company 110. Cloud server 111 accumulates log information of device A or device B ((a) in FIG. 1A). Here, the “log information” is, for example, information indicating an operating situation and operation date and time or the like of a plurality of devices 91. Examples of the log information include a viewing history of TV, recording reservation information of a recorder, operation date/time of a washing machine, volume of laundry, opening/closing date/time and opening/closing count of a refrigerator, but without being limited to them, the log information refers to all kind of information that can be acquired from all kinds of devices. The log information may be provided directly to cloud server 111 from a plurality of devices 91 themselves via the Internet. The log information may also be temporarily accumulated in home gateway 92 from the plurality of devices 91 and provided from home gateway 92 to cloud server 111.

Next, cloud server 111 of data center operating company 110 provides the accumulated log information to service provider 120 in certain units. Here, the unit may be a unit that the data center operating company can organize accumulated information and provide it to service provider 120 or a unit requested by service provider 120. Although the term “certain units” is described above, the unit may not be constant, and the amount of information provided may vary depending on the situation. The log information is saved in server 121 owned by service provider 120 ((b) in FIG. 1A). Service provider 120 organizes the log information into information suitable for services to be provided to the user and provides the log information to the user. The recipient user may be user 1 who uses a plurality of devices 91 or outside user 2. Regarding the method of providing a service to the user, a service may be directly provided from the service provider to the user, for example, ((e) and (f) in FIG. 1A). Alternatively, a service may be provided to the user via cloud server 111 of data center operating company 110 again ((c) and (d) in FIG. 1A). Alternatively, cloud server 111 of data center operating company 110 may organize the log information into information suitable for services to be provided to the user and provides the log information to service provider 120.

User 1 may be identical to or different from user 2.

### Embodiment 1

Embodiment 1 will be described.

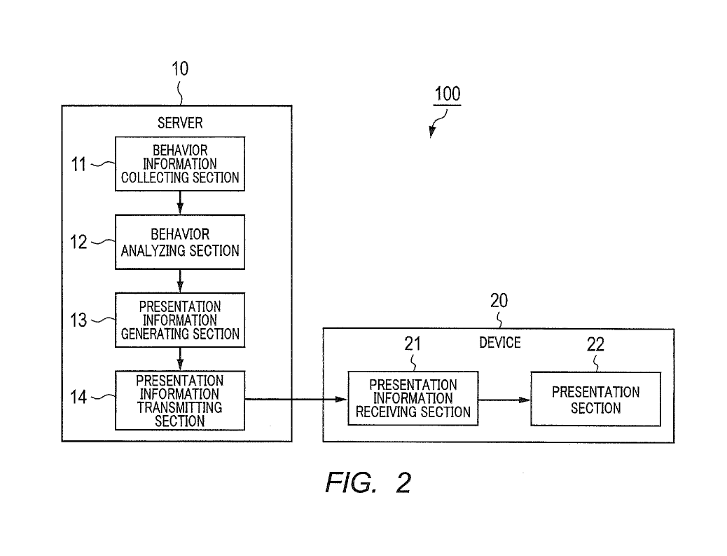

A configuration example of information providing system 100 according to the present embodiment will be described using FIG. 2 first. FIG. 2 is a block diagram illustrating a configuration example of information providing system 100.

In FIG. 2, information providing system 100 of the present embodiment is provided with server 10 (an example of server apparatus of the present invention) and device 20 (an example of information providing apparatus of the present invention). Server 10 and device 20 are connected via a wired network, a wireless network or a mixture thereof. In FIG. 2, only one device 20 is shown, but an assumption is made that there are a plurality of devices 20.

Suppose that examples of device 20 include appliances such as a TV, vacuum cleaner, air cleaner, washing machine, refrigerator, microwave oven, air-conditioner, electric toothbrush, and dryer. Alternatively, device 20 may also be an information terminal such as personal computer, mobile phone, smartphone, tablet or sensor such as blood glucose level sensor or appliances for toilet, bathroom, mirror and illumination or the like.

In addition, suppose that server 10 is a server operated and managed by a manufacturer or distributor of device 20 or an outsourcer entrusted by them.

Server 10 is provided with behavior information collecting section 11, behavior analyzing section 12, presentation information generating section 13, and presentation information transmitting section 14.

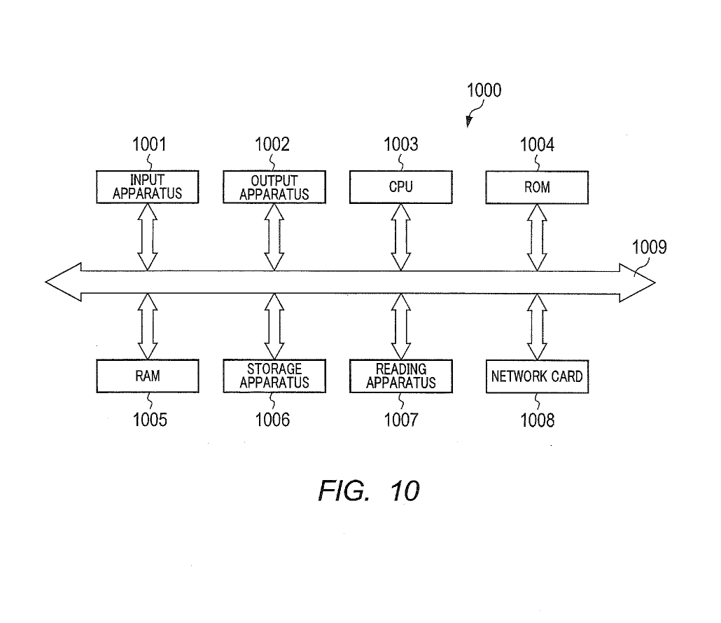

Behavior information collecting section 11 collects behavior information and stores the behavior information in a storage section (not shown) (e.g., corresponding to RAM 1005 or storage apparatus 1006 in FIG. 10). The behavior information is information relating to the behavior shown by the user when a malfunction occurs in a device used by the user (e.g., model identical to or similar to that of device 20). The similar model is a model similar to that of device 20. For example, a higher model and lower model have a relationship between similar models of the same brand. In addition, higher models of different release dates have a relationship between similar models. The behavior information is data reported from each user as appropriate and a set of this data is called “big data.” Behavior information collecting section 11 may collect the behavior information from device 20 or from predetermined apparatuses other than device 20.

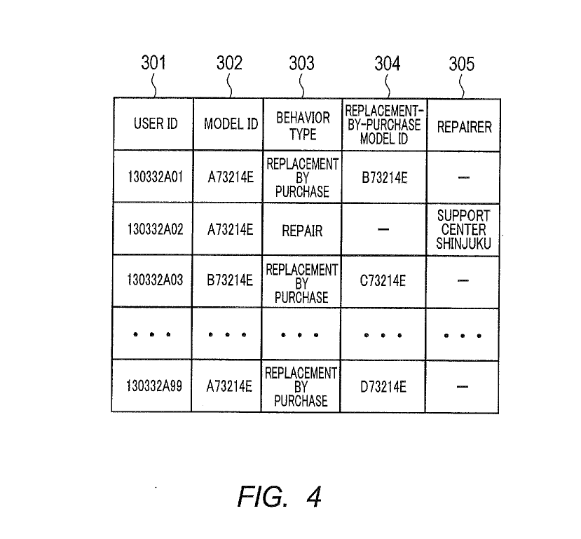

Examples of the latter include a computer at a store at which device 20 was purchased or a store at which device 20 was maintained, or a server that provides a web site to which the user of device 20 can input a purchase history or maintenance history. Note that the behavior information may be information inputted by the user or information generated by a device. A specific example of the behavior information will be described later using FIG. 4.

Behavior analyzing section 12 reads the behavior information collected by behavior information collecting section 11 from the storage section and analyzes what behavior is shown by each user in the event of a malfunction of the device based on the behavior information. For example, behavior analyzing section 12 analyzes whether each user has replaced the malfunctioning device by purchasing a new one (hereinafter referred to as “replacement by purchase”) or has the malfunctioning device repaired (hereinafter referred to as “repair”).

Behavior analyzing section 12 analyzes the newly purchased model (hereinafter referred to as “model replaced by purchase”) or a repairer used for repair based on behavior information collected by behavior information collecting section 11.

Details of each analysis described above will be described later.

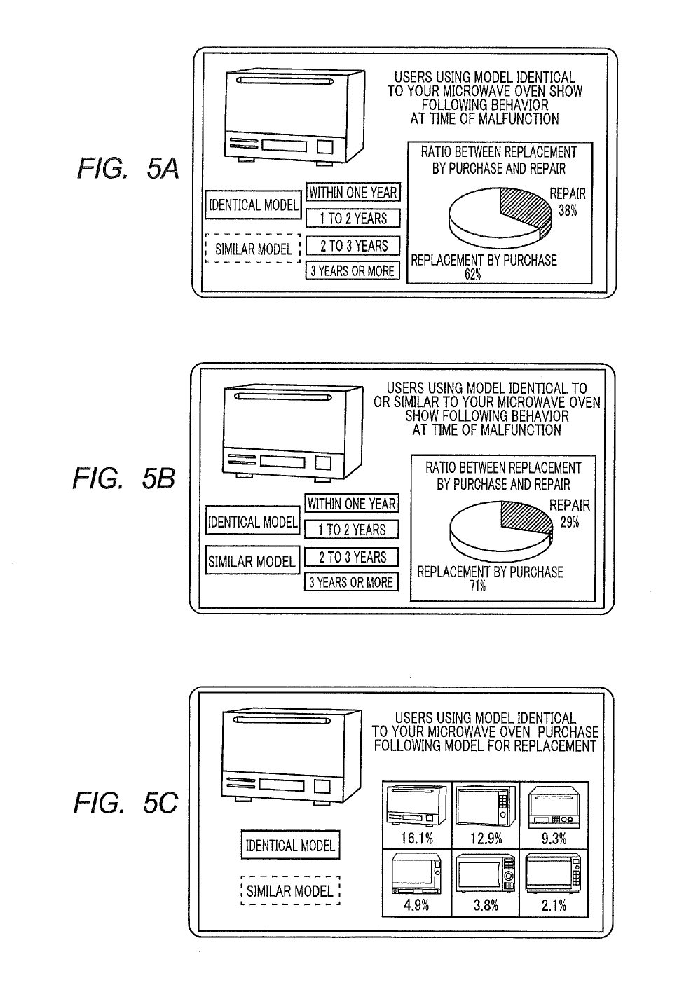

Presentation information generating section 13 generates presentation information based on the behavior analyzed by behavior analyzing section 12 (replacement by purchase or repair), model replaced by purchase and repairer. The presentation information is information presented to the user of device 20 (user of a model similar to that of device 20 may also be included) and used as a reference when selecting behavior to be shown in the event of a malfunction of the device. For example, the presentation information includes information on behavior shown by another user, model replaced by purchase by the other user, repairer entrusted by the other user or the like. A specific example of generating presentation information will be described later using FIGS. 5A to 5C.

Presentation information transmitting section 14 transmits the presentation information generated in presentation information generating section 13 to device 20 (model similar to that of device 20 may be included).

Device 20 includes presentation information receiving section 21 and presentation section 22.

Presentation information receiving section 21 receives presentation information transmitted from presentation information transmitting section 14 of server 10. The received presentation information is stored in a storage section (not shown) (e.g., corresponding to RAM 1005 or storage apparatus 1006 in FIG. 10). After that, an information processing section (not shown) reads the presentation information from the storage section and outputs the presentation information to presentation section 22.

Presentation section 22 presents the presentation information received by presentation information receiving section 21 to the user of device 20 using a predetermined method. An example of presentation is a method of displaying an image of the presentation information on a display provided for device 20. This image display screen may be accompanied by output of a sound (e.g., effect sound, guide speech). A specific example of presentation of the presentation information will be described later using FIGS. 5A to 5C.

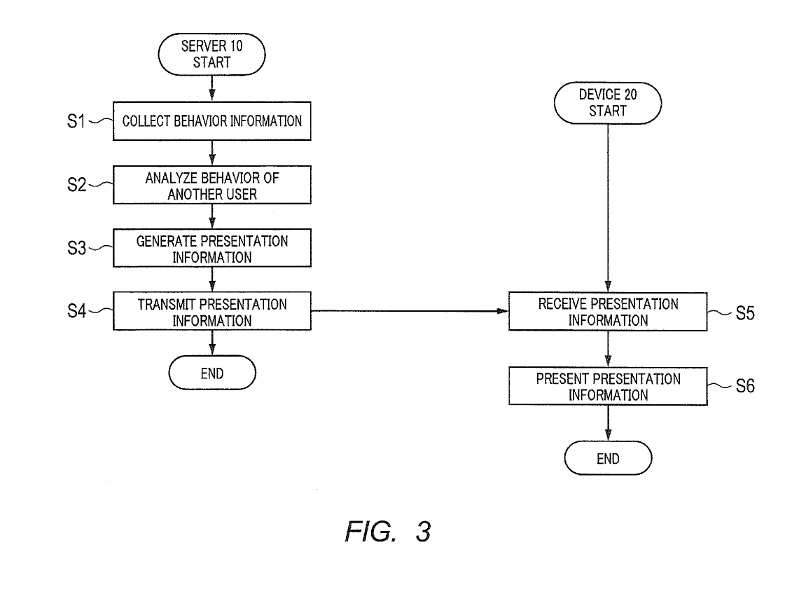

Next, an operation example of information providing system 100 according to the present embodiment will be described using FIG. 3. FIG. 3 is a sequence diagram illustrating an operation example of information providing system 100 according to the present embodiment. Hereinafter, a microwave oven will be described as an example of device 20.

In step S1, behavior information collecting section 11 of server 10 collects behavior information from a predetermined apparatus via, for example, the Internet and stores the behavior information in a storage section (not shown). Behavior information collecting section 11 then creates a data table that lists the collected behavior information. An example of this data table is shown in FIG. 4. FIG. 4 shows an example of the list of the collected behavior information.

In FIG. 4, the behavior information includes user ID 301, model ID 302, behavior type 303, replacement-by-purchase model ID 304 and repairer 305.

User ID 301 is identification information assigned to each user using a model identical to or similar to that of device 20.

Model ID 302 is identification information assigned to each model. Here, device ID 302 indicates a model currently being used by a user who did repair or a model used before replacement by purchase by a user who purchased a replacement.

Behavior type 303 is information indicating the type of behavior shown by the user in the event of a malfunction of the device. Here, behavior type 303 is one of replacement by purchase and repair.

Like model ID 302, replacement-by-purchase model ID 304 is identification information assigned to each model. Here, replacement-by-purchase model ID 304 indicates a model currently being used by a user who purchased a replacement. Thus, for the user who did repair, replacement-by-purchase model ID 304 shows no record (hyphens in FIG. 4).

Repairer 305 is information indicating a place to which the defective model was sent for repair (e.g., support center, store). Here, repairer 305 indicates a repairer of the model with model ID 302. For the user who purchased a replacement, repairer 305 shows no record (hyphens in FIG. 4).

Behavior information collecting section 11 collects and integrates the aforementioned behavior information to create a data table shown in FIG. 4. This data table is also stored in the storage section (not shown).

In step S2, behavior analyzing section 12 reads the data table shown in FIG. 4 from the storage section and analyzes the behavior shown by each user in the event of a malfunction of the device based on the data table. For example, behavior analyzing section 12 searches for users who purchased a replacement (the number of users whose behavior type 303 is “replacement by purchase”) and users who did repair (the number of users whose behavior type 303 is “repair”) for each model (model ID 302) and sums up the numbers of searched users. Behavior analyzing section 12 calculates a proportion of the respective summed the numbers of users in the total number of users (total number of pieces of behavior information). Hereinafter, this proportion will be referred to as “behavior ratio.” As the behavior ratio, for example, the following first to third behavior ratios are calculated. A first behavior ratio is a behavior ratio of a user of a model identical to that of device 20. A second behavior ratio is a behavior ratio of a user of a model similar to that of device 20. A third behavior ratio is a behavior ratio of a user combining the user of a model identical to that of device 20 and the user of a model similar to that of device 20.

Behavior analyzing section 12 analyzes a model replaced by purchase for a user who purchased a replacement based on the data table shown in FIG. 4. For example, behavior analyzing section 12 searches for a model replaced by purchase (replacement-by-purchase model ID 304) for each model (model ID 302) and sums up the numbers of models replaced by purchase. Behavior analyzing section 12 calculates a proportion of each of the summed numbers of models replaced by purchase in the total number of models replaced by purchase (total number of replacement-by-purchase model IDs 304 in (predetermined model ID 302). Hereinafter, this proportion will be referred to as “ratio of models replaced by purchase.” As the ratio of models replaced by purchase, for example, the following first to third ratios of models replaced by purchase are calculated. A first ratio of models replaced by purchase is a ratio of models replaced by purchase of a user of a model identical to that of device 20. A second ratio of models replaced by purchase is a ratio of models replaced by purchase of a user of a model similar to that of device 20. A third ratio of models replaced by purchase is a ratio of models replaced by purchase of a user combining the user of a model identical to that of device 20 and a user of a model similar to that of device 20.

Behavior analyzing section 12 analyzes a repairer for a user who did repair based on, for example, the data table shown in FIG. 4. For example, behavior analyzing section 12 searches for a repairer (repairer 305) for each model (model ID 302) and sums up the numbers of searched repairers. Behavior analyzing section 12 then calculates a proportion of each of the numbers of summed models replaced by purchase in the total number of repairers (total number of repairers 305 in predetermined model ID 302). Hereinafter, this proportion will be referred to as “repairer ratio.” As the repairer ratio, for example, the following first to third repairer ratios are calculated. A first repairer ratio is a repairer ratio of a user of a model identical to that of device 20. A second repairer ratio is a repairer ratio of a user of a model similar to that of device 20. A third repairer ratio is a repairer ratio of a user combining the user of a model identical to that of device 20 and the user of a model similar to that of device 20.

In step S3, presentation information generating section 13 generates presentation information including an analysis result by behavior analyzing section 12 (aforementioned behavior ratio, ratio of models replaced by purchase, repairer ratio). For example, presentation information generating section 12 generates a graph or the like illustrating the analysis result and generates image data to be displayed together with a typical message. A presentation example of presentation information will be described later using FIGS. 5A to 5C.

In step S4, presentation information transmitting section 14 transmits presentation information (e.g., above-described image data) to device 20 (may also include a model similar to that of device 20) via, for example, the Internet. Note that presentation information transmitting section 14 transmits image data based on previously stored destination information. The “destination information” is information (e.g., IP address) accessible to a device to which presentation information is transmitted (e.g., device 20, model similar to that of device 20 and other devices). Thus, image data as presentation information is transmitted to device 20.

Suppose the aforementioned presentation information is generated and transmitted, for example, when a predetermined useful life of device 20 comes to an end, when device 20 malfunctions or when the number of malfunctions that occur in devices of the same model as that of device 20 exceeds a predetermined number.

In step S5, presentation information receiving section 21 of device 20 receives presentation information (e.g., above-described image data) transmitted from presentation information transmitting section 14. After that, for example, the received image data is stored in the storage section (not shown). The image data is then read by presentation section 22 at predetermined timing.

In step S6, presentation section 22 presents the presentation information to the user of device 20. For example, presentation section 22 displays the above-described image data as the presentation information on the display of device 20. An example of this display screen is shown in FIG. 5A to FIG. 5C.

FIG. 5A shows an example of displayed images illustrating in a graph together with a typical message, what behavior is shown by users who use devices of a model identical to that of device 20 for a predetermined period of time when their devices malfunction (that is, the above-described first behavior ratio). The user can select the above-described predetermined period of time. For example, the user can select one of periods of service “within 1 year,” “1 to 2 years,” “2 to 3 years” and “3 years or more” as shown in FIG. 5A. This allows the user to know behavior classified by period of service.

When the user further selects model type “similar model” from the displayed image in FIG. 5A, an image in FIG. 5B is displayed. FIG. 5B is an example of displayed image illustrating in a graph what behavior is shown by users who use devices of a model identical that of device 20 and users who use devices of a model similar to that of device 20 when their devices malfunction (that is, the above-described third behavior ratio). In the case of the image display screen in FIG. 5B as well as the aforementioned case of the image display screen in FIG. 5A, the user may select a period of service. In the displayed image in FIG. 5A, if the user selects “similar model,” an image may be displayed only illustrating in a graph, what behavior is shown by users who use devices of a model similar to that of device 20 instead of the image in FIG. 5B when their devices malfunction (that is, the above-described second behavior ratio).

On the other hand, in the displayed image in FIG. 5A, when the user performs an operation of selecting a display screen of “replacement by purchase” (e.g., operation of specifying a touch operation on the display portion of “replacement by purchase” or using a pointer or the like), an image in FIG. 5C is displayed. FIG. 5C is an example of displayed image illustrating with a list, which models are purchased as replacement by users who use a model identical to that of device 20 when their devices malfunction (that is, the above-described first ratio of models replaced by purchase). Though not shown, when the user selects “repair” in the displayed image in FIG. 5A, an image is displayed in a list illustrating repairers to whom users who use devices of the same model as that of device 20 asked for repair when their devices malfunctioned (that is, the above-described first repairer ratio).

As described above, the present embodiment has a feature of providing a user who uses a predetermined device with information indicating what behavior is shown by users who use a model identical to or similar to that of the device when their devices malfunction. Therefore, it is possible to provide the user with information that serves as a reference in selecting either replacement by purchase or repair of the device. As a result, the user can select replacement by purchase, repair or other behavior using behavior of other users as a reference.

With Embodiment 1, the following modifications are possible.

For example, data is expressed in percentage in the graphs shown in FIG. 5A to FIG. 5C, but together with or instead of this, the total number of users who did replacement by purchase or the total number of users who did repair or the number of models replaced by purchase may be displayed.

The behavior type has been described by taking two cases: replacement by purchase and repair as examples, but other behavior types (e.g., disposal or unknown) may also be included.

For example, behavior information may also be included in usage log indicating a usage situation of device 20 or the like. The usage log is generated by device 20 when the user uses device 20, and is transmitted to server 10.

### Embodiment 2

Embodiment 2 will be described.

The present embodiment is intended to determine whether or not a user has high intention for replacement by purchase and control displaying of presentation information depending on the determination result.

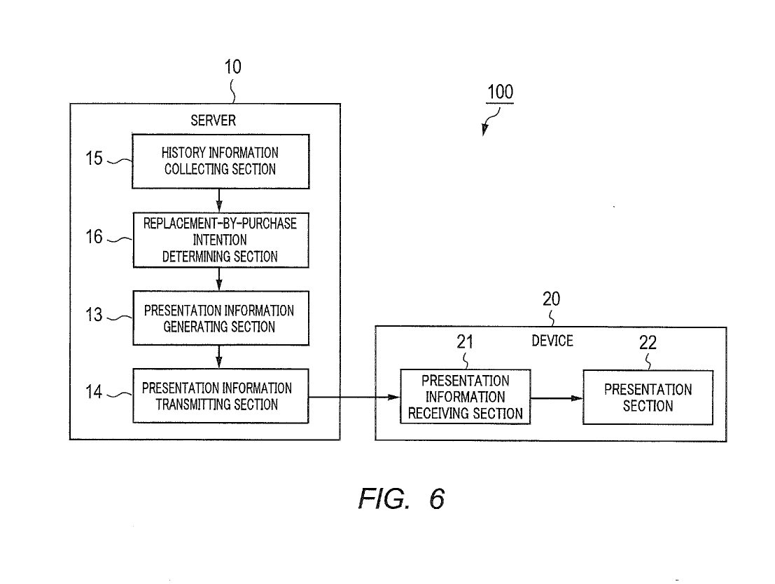

First, a configuration example of information providing system 100 according to the present embodiment will be described using FIG. 6. FIG. 6 is a block diagram illustrating a configuration example of information providing system 100. In FIG. 6, the same components as those in FIG. 1 are assigned the same reference numerals and description thereof will be omitted.

Server 10 is provided with history information collecting section 15 and replacement-by-purchase intention deter lining section 16 in addition to presentation information generating section 13 and presentation information transmitting section 14.

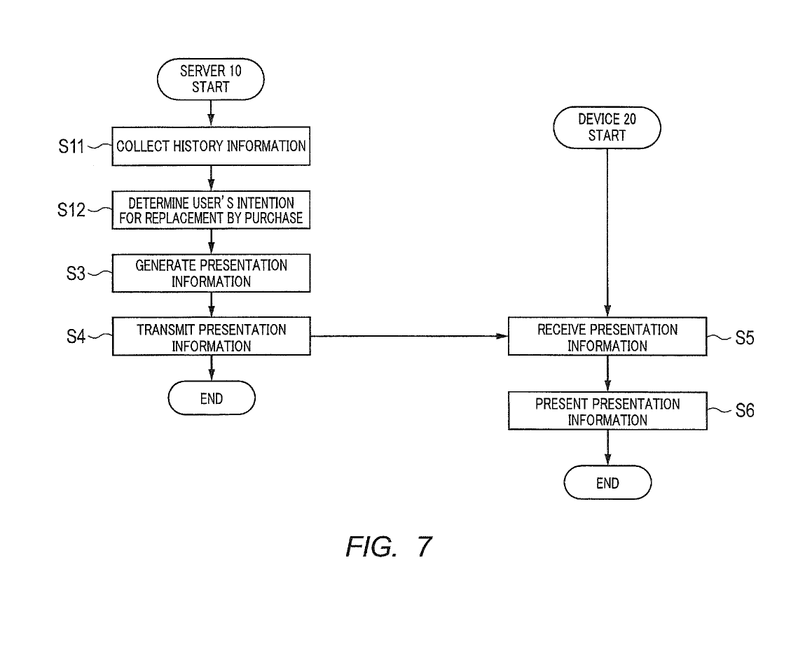

History information collecting section 15 collects history information. The history information is information including a user who uses device 20, other users who use the same model as that of device 20, history of device purchases (hereinafter referred to as “purchase history”), history of maintenance done on the device (hereinafter referred to as “maintenance history”). History information collecting section 15 may collect the history information from device 20 or collect it from a predetermined apparatus other than device 20. Examples of the latter include a computer at a store from which device 20 was purchased, at a store where device 20 was maintained or a server that provides a web site to which the user of device 20 can input the purchase history and maintenance history or the like. The history information may be information inputted by the user or information generated by the device. A specific example of the history information will be described later using FIG. 7.

Replacement-by-purchase intention determining section 16 determines whether the user's intention to purchase a replacement is high or low based on the history information collected by history information collecting section 15. A specific example of determining intention to purchase a replacement will be described later.

Presentation information generating section 13 generates presentation information based on the determination result by replacement-by-purchase intention determining section 16. A specific example of generating and displaying the presentation information will be described later.

Next, an example of operation of information providing system 100 according to the present embodiment will be described using FIG. 7. FIG. 7 is a sequence diagram illustrating an example of operation of information providing system 100 according to the present embodiment. A microwave oven will be described as an example of device 20 below.

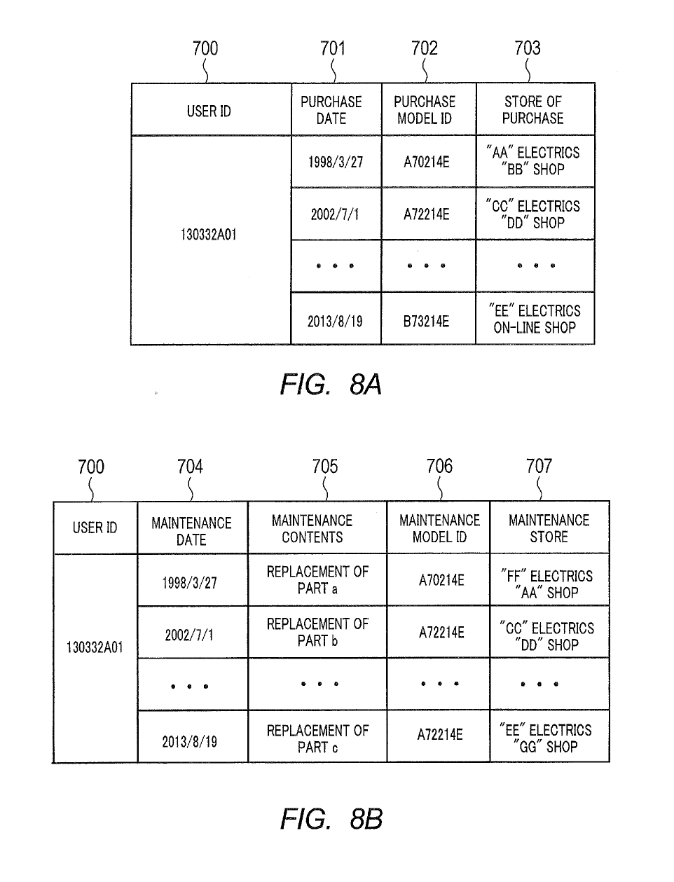

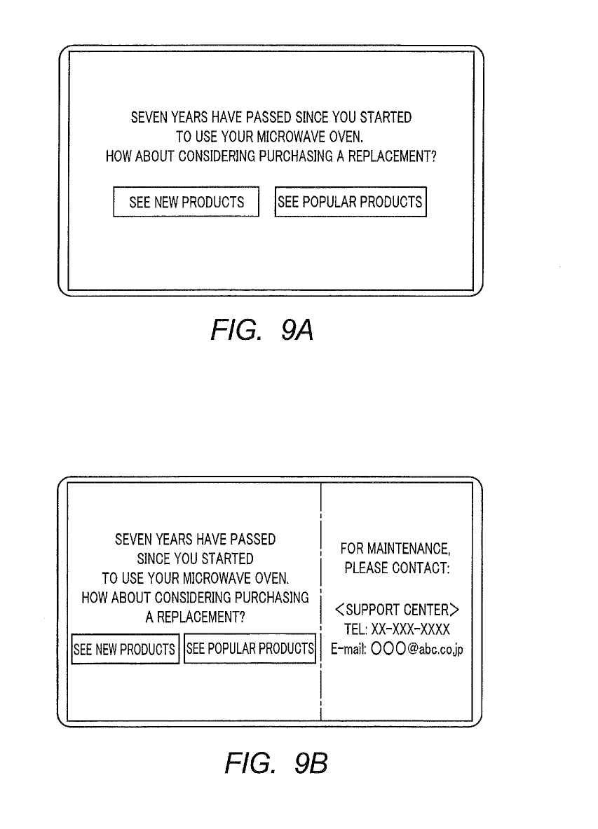

In step S11, history information collecting section 15 of server 10 collects history information via, for example, the Internet. Here, FIG. 8 shows an example of the collected history information. FIG. 8A illustrates an example of history information indicating a purchase history (hereinafter referred to as “purchase history information”). FIG. 8B illustrates an example of history information indicating a maintenance history (hereinafter referred to as “maintenance history information”).

In FIG. 8A, the purchase history information includes user ID 700, purchase date 701, purchase model ID 702 and purchase store 703. User ID 700 is identification information assigned to each user. Purchase date 701 is information indicating year/month/day on which a user purchased a model indicated by purchase model ID 702. Purchase model ID 702 is identification information indicating a model purchased by the user. Purchase store 703 is information indicating a store at which the user purchased a model indicated by purchase model ID 702 (may also include mail-order business web site).

In this way, the purchase history information is collected for each user.

In FIG. 8B, the maintenance history information includes user ID 700, maintenance date 704, maintenance contents 705, maintenance model ID 706, and maintenance store 707. User ID 700 is identification information assigned to each user and corresponds to user ID 700 of the purchase history information. Maintenance date 704 is information indicating the year/month/day on which a model used by the user was maintained. Maintenance contents 705 is information indicating contents of the maintenance FIG. 8B shows an example in which all maintenance contents 705 are “part replacement” but maintenance is not limited to this. Maintenance model ID 706 is identification information indicating the model maintained. Maintenance store 707 is information indicating a store to which the user requested to do maintenance about the contents indicated by maintenance contents 705. In this way, the purchase history information is collected for each user. Note that although the present embodiment assumes purchase history information and maintenance history as separate items, these items may be linked to one user ID 700.

In step S12, replacement-by-purchase intention determining section 16 determines for each user whether or not intention to purchase a replacement is high based on history information collected by history information collecting section 15 (e.g., purchase history information shown in FIG. 8A, maintenance history information shown in FIG. 8B). A specific example of this operation will be described below.

First, replacement-by-purchase intention determining section 16 counts and stores the number of purchase model IDs 702 (hereinafter referred to as “number of replacements by purchase by user”) for a predetermined period of time for each user ID 700 on the data table in FIG. 8A. A high intention ratio by user indicates that the user frequently purchases a replacement and a low intention ratio by user indicates that the user frequently does maintenance

Next, replacement-by-purchase intention determining section 16 counts and stores the number of maintenance contents 705 (hereinafter referred to as “maintenance count by user”) for the same period as the above-described predetermined period of time for each user ID 700 on the data table in FIG. 8B. Note that replacement-by-purchase intention determining section 16 may count the number of maintenance contents 705 by assigning weights thereto according to maintenance contents 705. For example, a greater weight may be assigned to replacement of a large part than replacement of a small part.

Next, replacement-by-purchase intention determining section 16 selects one user to be a determination target and calculates the number of replacements by purchase by user of the user and a maintenance count by user of the user. Hereinafter, this calculation result will be referred to as “intention ratio by user.”

Next, replacement-by-purchase intention determining section 16 selects all users other than the selected user and calculates the total number of replacements by purchase of the user group and a total maintenance count of the user group. Hereinafter, this calculation result will be referred to as “other user average intention ratio.”

Next, replacement-by-purchase intention determining section 16 compares the intention ratio by user with the other user average intention ratio. When the comparison result shows that the intention ratio by user is greater, the one user selected as the determination target is determined to have high intention for replacement by purchase.

On the other hand, when the comparison result shows that the intention ratio by user is smaller, the one user selected as the determination target is determined to have low intention for replacement by purchase (high repair intention).

A specific example of the process in step S12 has been described so far. The above-described determination process is an example and the level of intention to purchase a replacement may be determined by other processes.

In step S3, presentation information generating section 13 generates presentation information based on the determined level of intention to purchase a replacement. A specific example of this operation will be described below.

When the user's intention to purchase a replacement is high, presentation information generating section 13 generates presentation information with contents encouraging the user to purchase a replacement. This presentation information is, for example, image data including an image of a model as a candidate of replacement by purchase (hereinafter referred to as “replacement-by-purchase encouraging image data”) together with a typical message encouraging the user to purchase a replacement.

When the user's intention to purchase a replacement is low (repair intention is high), presentation information generating section 13 generates presentation information with contents encouraging the user to repair. This presentation information is, for example, image data including a contact address of a repairer or the like (hereinafter referred to as “repair encouraging image data”) together with a typical message encouraging the user to repair.

Presentation information generating section 13 may generate one or both of replacement-by-purchase encouraging image data and repair encouraging image data.

Timing of generating presentation information may be periodic or when the useful life of device 20 currently being used by the user is estimated to come to an end or when device 20 currently being used by the user malfunctions (including a predetermined period of time after malfunction).

Since the processes in steps S4, S5 and S6 have been described in FIG. 3, description thereof will be omitted here.

FIG. 9A and FIG. 9B show display screen examples of the presentation information in step S6. Both FIG. 9A and FIG. 9B are display screen examples when the user's intention to purchase a replacement is high.

FIG. 9A illustrates an example of a case where replacement-by-purchase encouraging image data is displayed on an entire display screen of device 20. Together with a typical message encouraging the user to purchase a replacement, two buttons (“see new products,” “see popular products”) are displayed to browse candidate models for replacement by purchase. When the user selects one button, an image is displayed to introduce candidate models for replacement by purchase.

FIG. 9B illustrates an example of a case where replacement-by-purchase encouraging image data and repair encouraging image data are displayed separately on the display of device 20. The replacement-by-purchase encouraging image data is the same as that shown in FIG. 9A. Although the replacement-by-purchase encouraging image data is not displayed on the entire display screen, its display size is larger than the display size of the repair encouraging image data. On the other hand, as the repair encouraging image data, a typical message for encouraging the user to repair and a contact address of a repairer are displayed. A ratio between the two image data display regions in FIG. 9B is predetermined.

FIG. 9A and FIG. 9B have shown display screen examples in the case where the user's intention to purchase a replacement is high, whereas in a case where the user's repair intention is high (when the user's intention to purchase a replacement is low), the following display screen appears. That is, repair encouraging image data is displayed on the entire display screen of device 20. Alternatively, after the display screen of device 20 is divided into two regions of different sizes, repair encouraging image data is displayed in the greater region and replacement-by-purchase encouraging image data is displayed in the smaller region.

As described above, the present embodiment has a feature of determining whether or not the user has high intention to purchase a replacement device and controlling the displaying of presentation information according to the determination result. This feature allows the user to receive information that matches the user's intention, and can thereby effectively encourage the user's behavior.

The following modifications are possible in present Embodiment 2.

For example, server 10 shown in FIG. 6 may be provided with behavior information collecting section 11 and behavior analyzing section 12. Thus, for example, the displayed images shown in FIG. 5A to FIG. 5C are applicable as presentation information generated and displayed in the present embodiment.

For example, history information may not only be a purchase history or maintenance history but also be a history (hereinafter referred to as “search history”) of searches for devices conducted by the user on web sites. In that case, when the number of searches for a predetermined device is equal to or above a threshold, replacement-by-purchase intention determining section 16 determines that the user has high intention for replacement by purchase.

An example of a case has been described where when the user has high intention for replacement by purchase, replacement-by-purchase encouraging image data is preferentially displayed by increasing the size of its display region, but the preferential display method is not limited to increasing the size of the display region. For example, visual attraction of replacement-by-purchase encouraging image data may be intensified or a specific symbol may be included in the image data. Furthermore, when both the replacement-by-purchase encouraging image data and repair encouraging image data are displayed, instead of simultaneously displaying divided regions as shown in FIG. 9B, a whole display screen as shown in FIG. 9A may be sequentially shown. For example, replacement-by-purchase encouraging image data may be displayed first for a predetermined period of time followed by repair encouraging image data for a shorter period of time than the display period of the replacement-by-purchase encouraging image data.

For example, when the user has high intention for replacement by purchase, timing of generating and displaying replacement-by-purchase encouraging image data may be advanced or the frequency of displaying the data may be increased. For example, before estimated timing of the useful life of device 20 currently being used by the user comes to an end, replacement-by-purchase encouraging image data may be generated and displayed periodically. On the other hand, when the user has low intention for replacement by purchase, repair encouraging image data may be displayed only when device 20 currently being used by the user malfunctions.

Embodiments 1 and 2 of the present invention have been described in detail with reference to the accompanying drawings so far, and the aforementioned functions of server 10 and device 20 can be implemented by a computer program.

FIG. 10 illustrates a hardware configuration of a computer that implements the functions of the apparatuses according to a program. This computer 1000 is provided with input apparatus 1001 such as a keyboard, mouse, touch pad, output apparatus 1002 such as a display and speaker, CPU (Central Processing Unit) 1003, ROM (Read Only Memory) 1004, and RAM (Random Access Memory) 1005. Computer 1000 is also provided with storage apparatus 1006 such as a hard disk drive and SSD (Solid State Drive), reading apparatus 1007 that reads information from a recording medium such as DVD-ROM (Digital Versatile Disk Read Only Memory), USB (Universal Serial Bus) and memory, and network card 1008 that performs communication via a network. The above-described sections are connected via bus 1009.

Reading apparatus 1007 reads a program for implementing the functions of the respective apparatuses from a recording medium that stores the program and causes storage apparatus 1006 to store the program. Alternatively, network card 1008 communicates with a server apparatus connected to the network and causes storage apparatus 1006 to store the program downloaded from the server apparatus for implementing the functions of the respective apparatuses.

CPU 1003 copies the program stored in storage apparatus 1006 to RAM 1005, sequentially reads instructions included in the program from RAM 1005 and executes the instructions, and thereby implements the functions of the above-described apparatuses.

The technique described in the above embodiments can be implemented in the following cloud service genres. However, the genres in which the techniques described in the above-described embodiments are not limited to these genres.

(Service Genre 1: Own Data Center Type)

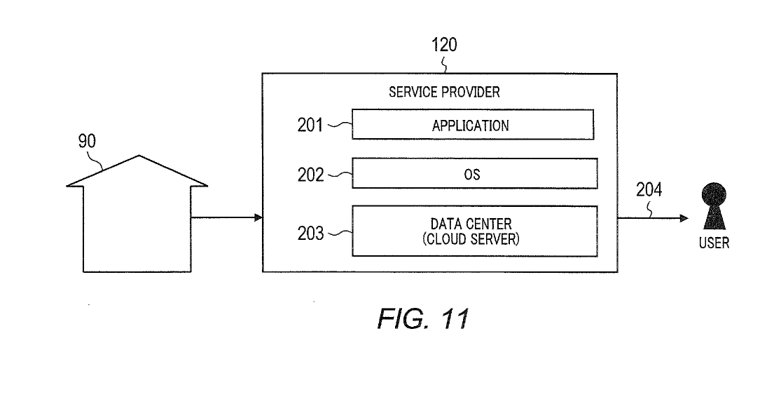

FIG. 11 illustrates service genre 1 (own data center type). This genre is a genre in which service provider 120 acquires information from group 90 and provides a service to users. In this genre, service provider 120 has a function of a data center operating company. That is, service provider 120 owns cloud server 111 that manages big data. Therefore, there is no data center operating company.

In this genre, service provider 120 operates and manages a data center (cloud server 111) (203). Service provider 120 also manages OS (202) and application (201). Service provider 120 provides a service (204) using OS (202) and application (201) managed by service provider 120.

(Service Genre 2: Type Using IaaS)

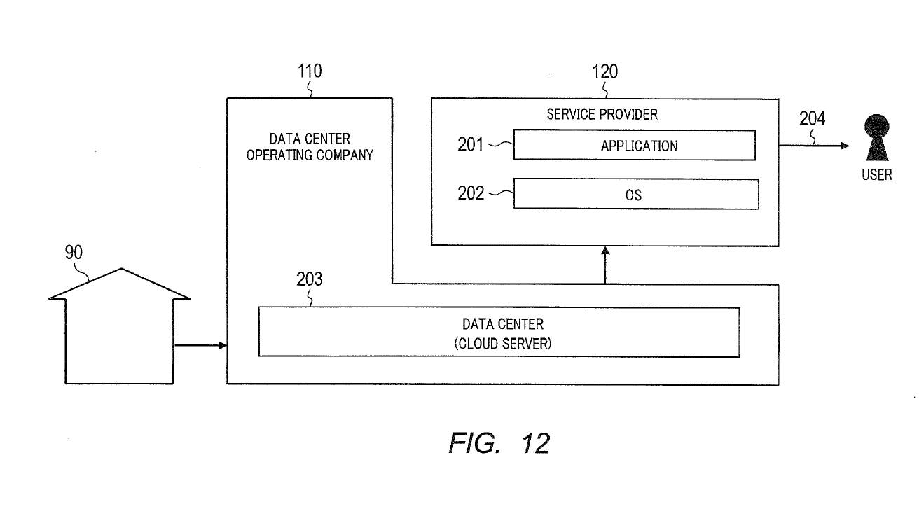

FIG. 12 illustrates service genre 2 (type using IaaS). Here, “IaaS” is an abbreviation of “infrastructure as a service,” and is a cloud service providing model that provides an infrastructure itself for constructing and operating a computer system as a service via the Internet.

In this genre, data center operating company 110 operates and manages a data center (cloud server 111) (203). Service provider 120 manages OS (202) and application (201). Service provider 120 provides service (204) using OS (202) and application (201) managed by service provider 120.

(Service Genre 3: Type Using PaaS)

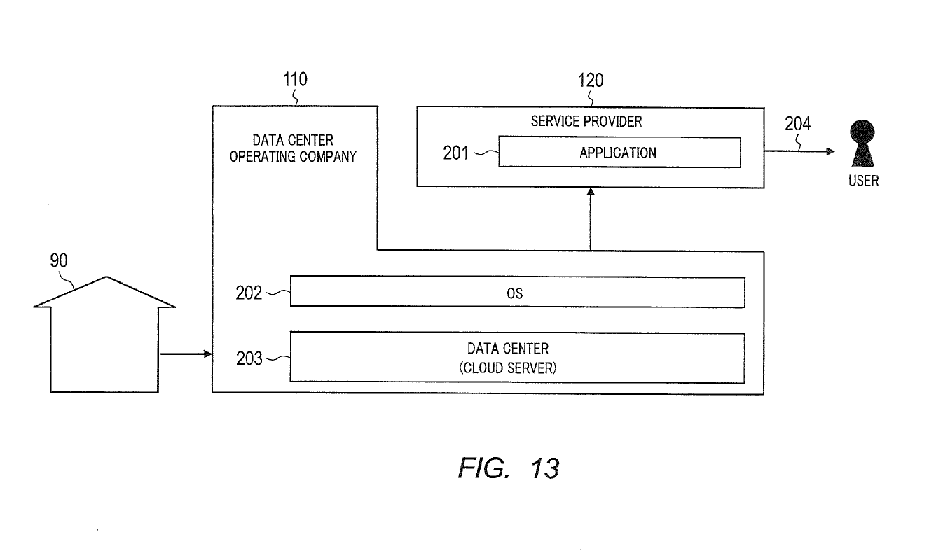

FIG. 13 illustrates service genre 3 (type using PaaS). Here, “PaaS” is an abbreviation of “platform as a service” and is a cloud service providing model that provides a platform which becomes a base for constructing and operating software as a service via the Internet.

In this genre, data center operating company 110 manages OS (202) and operates and manages a data center (cloud server 111) (203). Service provider 120 manages application (201). Service provider 120 provides a service (204) using OS (202) managed by data center operating company 110 and application (201) managed by service provider 120.

(Service Genre 4: Type Using SaaS)

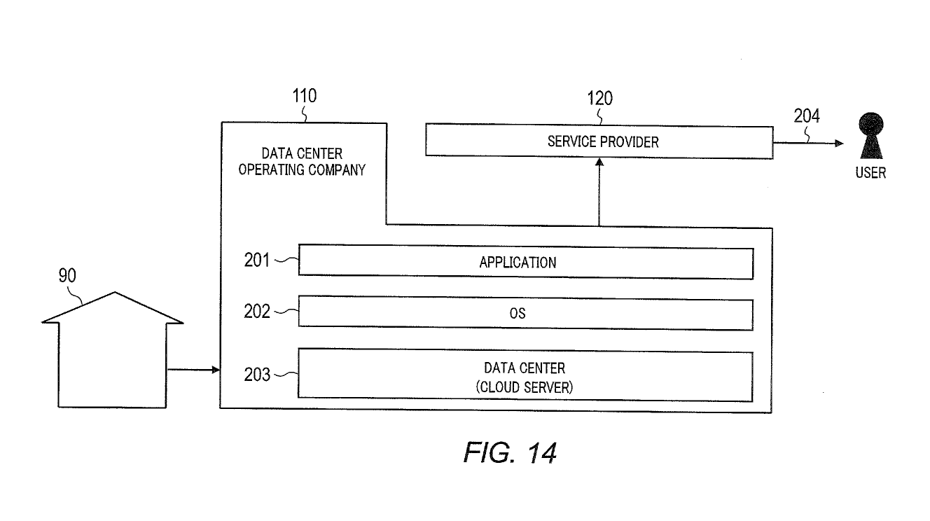

FIG. 14 illustrates service genre 4 (type using SaaS). Here, “SaaS” is an abbreviation of “software as a service.” SaaS is a cloud service providing model having a function that allows a company/individual (user) owning no data center (cloud server 111) to use application 201 provided by a platform provider owning, for example, a data center (cloud server 111) via a network such as the Internet.

In this genre, data center operating company 110 manages application (201), manages OS (202), and operates and manages a data center (cloud server 111) (203). Service provider 120 provides a service (204) using OS (202) and application (201) managed by data center operating company 110.

In all the genres described above, suppose service provider 120 proves a service. Furthermore, for example, service provider 120 or data center operating company 110 itself may develop OS 202, application 201, a database of big data or the like or may outsource the development to a third party.

The present invention is not limited to the above-described embodiments, and but can be modified without departing from the spirit and scope of the invention.

The disclosure of Japanese Patent Application No. 2013-177690, filed on Aug. 29, 2013, including the specification, drawings and abstract is incorporated herein by reference in its entirety.

### INDUSTRIAL APPLICABILITY

The present invention is useful as a technique for providing users with information relating to home appliances to (e.g., an apparatus, system, method, and program).

### REFERENCE SIGNS LIST

1, 2 User
10 Server
11 Behavior information collecting section
12 Behavior analyzing section
13 Presentation information generating section
14 Presentation information transmitting section
15 History information collecting section
16 Replacement-by-purchase intention determining section
20 Device
21 Presentation information receiving section
22 Presentation section
90 Group
91 Device
92 Home gateway
100 Information providing system
110 Data center operating company
111 Cloud server
120 Service provider
121 Server
201 Application
202 OS
203 Data center
204 Provision of service
301, 700 User ID
302 Model ID
303 Behavior type
304 Replacement-by-purchase model ID
305 Repairer
701 Purchase date
702 Purchase model ID
703 Purchase store
704 Maintenance date
705 Maintenance contents
706 Maintenance model ID
707 Maintenance store
1000 Computer
1001 Input apparatus
1002 Output apparatus
1003 CPU
1004 ROM
1005 RAM
1006 Storage apparatus
1007 Reading apparatus
1008 Network card
1009 Bus

1. An information providing apparatus comprising:
a presentation information receiving section that receives presentation information generated in a server apparatus and that stores the presentation information in a predetermined storage section; and
a presentation section that presents the presentation information read from the storage section to a user of a predetermined device, wherein
the presentation information is information that indicates, by behavior type, what behavior is shown by at least one of a user of a model identical to that of the device and a user of a model similar to that of the device when the device used by the user malfunctions.

2. The information providing apparatus according to claim 1, wherein the presentation information includes information indicating a newly purchased model as a replacement when replacement by purchase is done as the behavior.

3. The information providing apparatus according to claim 1, wherein the presentation information includes information indicating a repairer used when repair is done as the behavior.

4. The information providing apparatus according to claim 1, wherein the presentation information includes at least one of information that encourages a user determined to have high intention for replacement by purchase to purchase a replacement and information that encourages a user determined to have high intention for repair to do repair.

5. A server apparatus comprising:
a behavior information collecting section that collects behavior information relating to behavior shown by a user when a device used by the user malfunctions and that stores the behavior information in a predetermined storage section;
a behavior analyzing section that analyzes, for each user, what behavior is shown by the user when the device malfunctions, based on the behavior information read from the storage section;
a presentation information generating section that generates presentation information indicating, by behavior type, what behavior is shown by at least one of a user of a device of a model identical to that of the device and a user of a model similar to that of the device when the device malfunctions, based on the analysis result; and
a presentation information transmitting section that transmits the presentation information to an apparatus used by the user.

6. The server apparatus according to claim 5, wherein
when analyzing that replacement by purchase is done as the behavior based on the behavior information, the behavior analyzing section determines a model replaced by purchase, and
the presentation information generating section generates the presentation information so that the presentation information includes information indicating a plurality of the models replaced by purchase.

7. The server apparatus according to claim 5, wherein
when analyzing that repair is done as the behavior based on the behavior information, the behavior analyzing section determines a repairer, and
the presentation information generating section generates the presentation information so that the presentation information includes information indicating a plurality of the repairers.

8. The server apparatus according to claim 5, further comprising:
a history information collecting section that collects history information relating to a history of devices purchased by the user and a history of maintenance of a device done by the user;
a replacement-by-purchase intention determining section that determines, for each user, whether or not the user has high intention for replacement by purchase based on the history information;
a presentation information generating section that generates presentation information for encouraging the user to purchase a replacement when the intention for replacement by purchase is determined to be high or that generates presentation information for encouraging the user to do repair when the intention for replacement by purchase is determined to be low; and
a presentation information transmitting section that transmits the presentation information to an apparatus used by the user.

9. An information providing method performed by a server apparatus disposed on a network, the method comprising:
collecting behavior information relating to behavior shown by a user when a device used by the user malfunctions, and storing the behavior information in a predetermined storage section;
analyzing, for each user, what behavior is shown by the user, based on the behavior information read from the storage section when the device malfunctions;
generating presentation information indicating, by behavior type, what behavior is shown by at least one of a user of a device of a same model as that of the device and a user of a model similar to that of the device when the device malfunctions, based on the analysis result; and
transmitting the presentation information to an apparatus used by the user.

10. (canceled)
